(19) United States
(12) Patent Application Publication
(10) Pub. No.: US 2021/0336482 A1
(43) Pub. Date: Oct. 28, 2021

(54) ELECTRIC POWER BASE

(71) Applicant: EGGTRONIC ENGINEERING S.P.A., MODENA (MO) (IT)

(72) Inventors: Igor SPINELLA, MODENA (MO) (IT); Camilla BETTINELLI, MODENA (MO) (IT); Fabrizio CARAMASCHI, CARPI (MO) (IT)

(21) Appl. No.: 17/240,032

(22) Filed: Apr. 26, 2021

(30) Foreign Application Priority Data
Apr. 28, 2020 (IT) 102020000009229

(51) Int. Cl. H02J 50/10; H01F 38/14; H02J 50/90

(52) U.S. Cl. CPC H02J 50/10; H02J 50/90; H01F 38/14

(57) ABSTRACT

There is described an electric power base (100), comprising: a casing (105), a wireless transmitter (110) of electric energy placed in the casing (105), an interface surface (140) placed external to the casing (105) at said wireless transmitter (110) which is adapted to receive in contact a device (500) to be powered, and at least one electromagnet (150) adapted to generate a magnetic pull from the outside towards the interface surface (140).

### TECHNICAL FIELD

The present invention relates to a wireless power base which may be used to “wirelessly” power electric/electronic devices of various type, for example but not exclusively smartphones, laptop computers, tablet computers or any other portable device.

### STATE OF THE ART

Several wireless power bases currently are known on the market which for example, through an inductive transmission system, are capable of electrically powering the aforesaid devices, for example in order to charge the internal batteries thereof. Some of these power bases operate when connected to an electric energy source, while others, also known with the name of wireless power bank, are provided with an internal accumulator, typically a battery, so as to be transported and used when a connection point to the power grid is not available.

A common feature to all wireless power bases is the fact that in order to allow an efficient transmission of the electric energy, the power base and the device to be powered are to be positioned in a rather accurate manner with respect to each other in order to ensure the correct alignment between a wireless transmitter of electric energy, placed in the power base, and a wireless receiver of said electric energy, placed in the device to be powered.

For example, if the power base implements an inductive transmission technology, at least one transmission coil of the power base is to be aligned with a corresponding receiving coil of the device to be powered.

For this reason, most wireless power bases are provided with at least one interface surface, which is generally identified by means of suitable graphic, touch and/or illuminated spots on which the users are to rest the device to be powered so the desired transmission of electric energy can occur.

To ensure a highly efficient transmission of the electric energy, it generally is not sufficient to rest the device to be powered on the interface surface, rather it is necessary to arrange it in the position that ensures the best possible alignment between the transmitter of the charging base and the receiver of the device to be powered.

This positioning requires a certain degree of attention by the users and may be easily compromised in case of knocks, vibrations or other stresses that cause accidental movements between the device to be powered and the charging base. This latter problem, which in itself is not particularly critical when the power bases are used in static contexts, for example at home or in the office, is extremely felt when the power bases are used in mobility, for example when travelling.

In particular, it is impossible or extremely complicated to maintain the correct alignment between the power base and the device to be powered when the same are transported in a bag or rucksack or pocket, or when the device to be powered is used while it is charging resting on the power base.

Various solutions aiming to improve the adhesion of the device to be charged to the interface surface of the power base have been explored in the past to try and overcome this drawback.

A first solution was the one of using non-slip rubber inserts, which however do not allow keeping the parts joined, making the transmission of electric energy impossible in situations of great instability, for example should the power base and the device to be powered be transported in a bag or rucksack.

A second solution was the one of using adhesive rubber inserts, which however have the drawback of attracting dust and becoming dirty very quickly, not only not being very hygienic but quickly losing also the efficacy thereof in terms of adhesive effect.

Another known solution was the one of providing the power base with a plurality of suction cups at the interface surface, which suction cups have the advantage of stably coupling the device to be powered to the power base but they may not be highly appreciated from an aesthetical viewpoint.

Finally, a fourth solution was the one of using a double-sided adhesive layer, which however has the drawback of creating an almost irremovable connection between the power base and the device to be powered.

The result is that none of the solutions proposed to date is completely satisfactory. Moreover, none of these solutions allows automatically achieving the correct alignment (centring) between the device to be powered and the power base, in any case forcing the users to pay a certain attention in the step in which they carry out the coupling.

### DESCRIPTION OF THE INVENTION

In light of the above, it is an object of the present invention to resolve or at least mitigate the drawbacks of the known art, making available a system that allows efficiently joining the device to be powered and the power base which does not attract dust, is stable and does not have an excessive impact on the aesthetical aspect.

It is another object to provide a system that may achieve a self-alignment effect between the device to be powered and the power base.

It is a further object to achieve the aforesaid objects within the scope of a simple, rational and affordable solution.

These and other objects are achieved thanks to the features of the invention as set forth in the independent claim. The dependent claims outline preferred and/or particularly advantageous aspects of the invention, without however being essential for the implementation thereof.

In particular, the invention makes available an electric power base comprising:
a casing,
a wireless transmitter of electric energy placed in the casing,
an interface surface placed external to the casing at said wireless transmitter which is adapted to receive in contact a device to be powered, and
at least one electromagnet, for example received in the casing, adapted to generate a magnetic pull from the outside towards the interface surface.

Thanks to this solution, it advantageously is possible, by simply nearing the device to be powered to the interface surface of the power base, to obtain an automatic adhesion between these two objects that allows keeping the device to be powered joined to the power base also in unstable situations.

Moreover, the magnetic force generated by the electromagnet always tends to re-tract the device to be powered towards an accurate position, typically towards a position of minimum distance from the electromagnet itself.

Therefore, if suitably positioned, the electromagnet may achieve an automatic alignment between the wireless transmitter of the power base and a corresponding wireless receiver of the device to be powered, even if these two devices are mutually neared without particular attention or should they move slightly with respect to each other, thus always ensuring an efficient transmission of electric energy from the power base to the device to be powered.

According to an embodiment, the wireless transmitter of electric energy may be of the capacitive type, i.e. it may comprise at least two armatures adapted to be capacitively coupled with at least two corresponding armatures placed in the device to be powered so as to achieve an overall pair of capacitances through which the electric energy may pass.

However, a preferred embodiment of the invention provides for the wireless transmitter of electric energy to be of the inductive type, i.e. which may comprise an inductive transmission coil wound about a pre-set winding axis, that is adapted to be inductively coupled with a corresponding inductive coil (e.g. a corresponding antenna) in the device to be powered.

Both these solutions, each with their own peculiarities and characteristic advantages, is capable of ensuring a rather safe and efficient transmission of electric energy.

However, the inductive solution allows achieving an improved integration between the wireless transmitter of electric energy and the electromagnet.

For example, a first embodiment of the invention provides for the electromagnet to comprise the inductive transmission coil of the wireless transmitter.

This solution has the advantage of automatically accurately centring the wireless transmitter of the power base and the wireless receiver of the device to be powered, without the need for additional devices and therefore without increasing costs and overall dimensions.

In this context, an aspect of the invention provides for the power base to comprise an energizing electric circuit configured to power the inductive transmission coil both with an alternating current and with a direct current.

In this way, the electric current continues allowing the inductive coil to behave as electromagnet, while the alternating current allows it to act as transmitter of electric energy.

Another aspect of this embodiment provides for the inductive transmission coil to be associated with a body made of ferromagnetic material.

Thanks to this solution, it advantageously is possible to increase both the trans-mission efficiency of the electric power and the generating efficiency of the magnetic field.

In particular, said body made of ferromagnetic material may be provided with a flat surface and a protrusion which rises from said flat surface, for example towards the interface surface, centrally with respect to the inductive transmission coil. In this way, it is possible to improve the self-centring effect between the wireless transmitter and the receiver because such solution allows increasing the concentration of magnetic force in a precise area, inside the coil of the wireless transmitter. A second embodiment of the invention provides for the electromagnet to comprise an auxiliary coil that is independent of the inductive transmission coil. Thanks to this solution, the auxiliary winding may be optimized only to generate the magnetic pull.

For example, given that a high-frequency alternating current is not to flow through it, the auxiliary coil may be made with conductors having reduced section with respect to those of the inductive transmission coil, thus being more affordable and compact.

A reduced section of these conductors also allows increasing the number of turns of the auxiliary coil and therefore increasing the magnetic pull that can be obtained with a small driving current.

According to an aspect of this embodiment, the auxiliary coil may be wound about a winding axis passing through the inductive transmission coil and parallel to the winding axis thereof (for example coinciding therewith).

In this way, it advantageously is possible to preserve a self-centring effect that tends to automatically align the inductive transmission coil with the receiving coil placed in the device to be powered.

According to an aspect of this embodiment, the auxiliary coil may be associated with the same body made of ferromagnetic material with which the inductive trans-mission coil also may be associated, both internal and external to the latter. In this way, a significant integration is obtained between the electromagnet and the wireless transmitter, which allows obtaining an effective magnetic pull and an effective self-centring effect within the scope of a compact solution with curbed overall dimensions.

To further increase these effects, the auxiliary coil may for example, be partly wound on the protrusion that may rise from the flat surface of said body made of ferromagnetic material centrally with respect to the inductive coil.

Regardless of the specific embodiment used, another aspect of the invention provides for the power base to comprise an electronic control arrangement configured to activate the electromagnet at the same time as the wireless transmitter.

In this way, during the transmission of electric energy towards the device to be powered, the power base advantageously is capable of also exerting a simultaneous magnetic pull that keeps the two devices joined, thus preventing them from being separated or in any case being misaligned due to knocks, movements or other external stresses, in particular but not exclusively, in situations of mobility.

According to another aspect of the invention, the electronic control arrangement could be configured to activate the electromagnet or the wireless transmitter in an alternative manner.

Thanks to this solution, the electromagnet is only used when electric power is not being transmitted and vice versa, thus obtaining a savings in terms of energy consumption.

It is in any case preferable in both cases for the electronic control arrangement to be configured to activate the electromagnet for a predetermined time period, typical lasting less with respect to the time period for activating the wireless transmitter.

In this way, the magnetic field is generated for relatively short periods of time, reducing the consumption and the possibility of generating harmful eddy currents in the device to be powered, for example in the battery thereof.

For example, the electronic control arrangement may be configured to activate the electromagnet for a predetermined time period when an inductive coupling is detected between the wireless transmitter and the wireless receiver of the device to be powered.

Furthermore, it may be provided for the electronic control arrangement to be configured to activate the electromagnet for a predetermined time period when a worsening is detected of the transmission efficiency of the electric power between the wireless transmitter and the wireless receiver.

A further configuration may provide for the electronic control arrangement to be configured to activate the electromagnet periodically for short periods of time, alternated by periods of interruption, in order to ensure a constant contact and centring of the two devices.

According to a different aspect of the invention, the power base may further comprise an accumulator of electric energy, such as for example a rechargeable battery, connected to the wireless transmitter.

In this way, the power base essentially is configured as a portable wireless power bank, which may advantageously be used to power electronic devices also in the absence of a connection point to the power grid.

It is important to underline that the features hereto described, with the aim of promoting the contact to be maintained between the device to be powered and the power base, and also the one of promoting the relative centring between the wireless power transmission devices, may be translated from the power base to the device to be powered.

Accordingly, the invention also makes available a device to be powered, comprising:
a casing,
a wireless receiver of electric energy placed in the casing,
an interface surface placed external to the casing at said wireless receiver which is adapted to receive in contact an electric power base, and
at least one electromagnet adapted to generate a magnetic pull from the outside towards the interface surface.

### BRIEF DESCRIPTION OF THE FIGURES

Further features and advantages of the invention will be more apparent after reading the following description provided by way of a non-limiting example, with the aid of the accompanying drawings.

FIG. 1 is a view from above of a power base according to the present invention.

FIG. 2 is a side view of the power base of FIG. 1, during a step of use.

FIG. 3 is section III-Ill of FIG. 1, related to a first embodiment of the invention.

FIG. 4 is the section of FIG. 3, related to a second embodiment of the invention.

FIG. 5 is the section of FIG. 3, related to a third embodiment of the invention.

FIG. 6 shows a section view of a device to be powered resting on a power base according to a further embodiment of the invention.

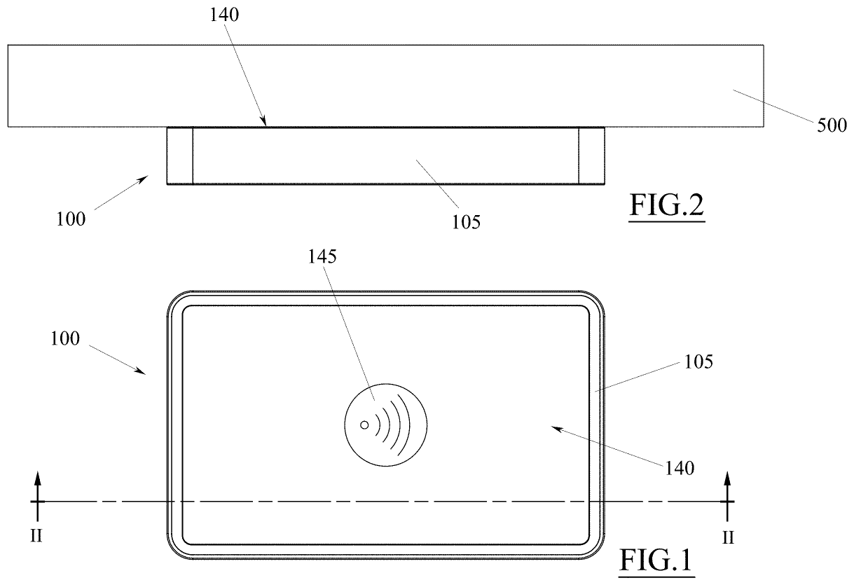

### DETAILED DESCRIPTION

With reference to the above-mentioned drawings, a power base is indicated with 100, the power base being adapted to electrically power one or more electric/electronic devices 500, for example to charge the internal batteries thereof and/or simply to allow the operation thereof.

The devices 500 may be for example, smartphones, laptop computers, tablet computers or any other portable device, without however necessarily excluding devices that can be considered fixed, such as televisions, lamps and much more.

The power base 100 firstly comprises a casing 105, i.e. a casing adapted to define the outer shape thereof.

In the embodiment illustrated, the casing 105 is substantially shaped as a stand-alone object, which may have sufficiently curbed dimensions to be easily transported from one place to another, for example in rucksacks, bags or other similar containers.

The outer shape of the casing 105 may obviously vary significantly for aesthetical reasons or for other reasons and is not a significant aspect of the present disclosure.

In other embodiments, the casing 105 could be defined and/or integrated in a more complex and/or cumbersome object possibly intended for substantially stationary applications, such as a table, desk, armrest, mobile container or another furnishing element, thus enriching the functionalities of this object with the possibility of also powering devices 500 associated, and/or that can be associated, therewith.

The power base 100 further comprises at least one wireless transmitter 110 of electric energy, which is contained in the casing 105 and is adapted to transmit electric energy externally in wireless manner, i.e. in the shape of electromagnetic waves carried wirelessly.

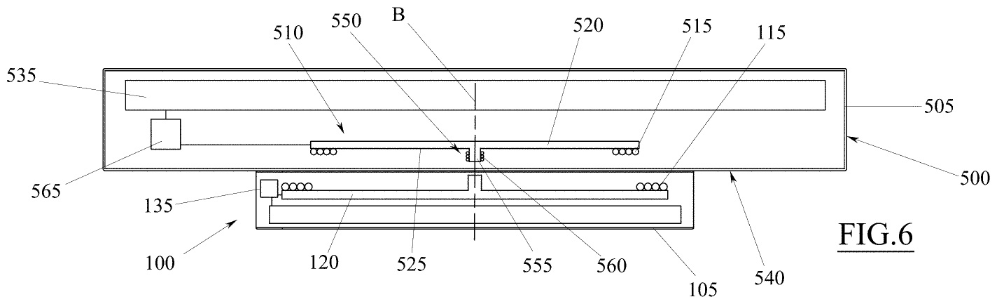

In the accompanying drawings, the wireless transmitter 110 is of the inductive type and therefore comprises at least one inductive transmission coil 115 which is adapted to be inductively coupled with a corresponding inductive receiving coil in the device 500 to be powered (see for example, the receiving coil 515 in FIG. 6). The inductive transmission coil 115 is wound at a pre-set winding axis A.

In other words, the inductive transmission coil 115 comprises a body made of electrically conductive material (for example a wire or a conductive foil), which is wound about the winding axis A so as to form one or more coaxial, and possibly coplanar, turns.

The inductive transmission coil 115 may be associated with a body 120 made of ferromagnetic material (such as for example, ferrite) so that an electric current flowing through the inductive transmission coil 115 generates a magnetic field in the ferromagnetic body 120.

The body 120 made of ferromagnetic material preferably is shaped as a plate that has a flat surface 125 on which the turns of the inductive transmission coil 115 may be applied in coplanar manner.

In this way, the winding axis A substantially is orthogonal to the flat surface 125 of the body 120 made of ferromagnetic material.

The electric energy transmitted by the wireless transmitter 110 may come directly from a fixed power distribution network, to which the power base 100 may for example, be connected via cable.

More preferably however, said electric energy comes from a suitable accumulator 130 of electric energy, for example from one or more lithium batteries or batteries of any other type, which accumulator is contained in the casing 105 and is electrically connected with the wireless transmitter 110.

The presence of this accumulator 130, which may be of the rechargeable type, configures the power base 100 as a so-called wireless power bank, which may be effectively used to power devices 500 also in mobility or in any case in all the cases in which a connection point to the power grid is not available.

To allow the transfer of electric energy to the device 500, the power base 100 may also comprise an energizing electric circuit 135, for example a suitable conversion circuit of the switching type, which is adapted to transform the input voltage, for example the direct voltage provided by the accumulator 130, into a suitable AC excitation, i.e. into a sequence of, preferably high-frequency, voltage waves and/or electric current that is applied to the wireless transmitter 110, i.e. to the inductive transmission coil 115.

In order for the transmission of electric energy to occur efficiently, it however generally is necessary for the device 500 to be powered to be in a pre-set position with respect to the wireless transmitter 110, or in any case within a predetermined range of positions.

In particular, in the examples illustrated, it is necessary for the inductive transmission coil 115 to be aligned with the corresponding inductive receiving coil placed in the device 500 to be powered.

For this reason, the power base 100 makes available, external to the casing 105, at least one interface surface 140, which is adapted to receive resting, or in any case in contact, the device 500 to be charged and is positioned at the wireless transmitter 110 in such a manner whereby when the device 500 is resting or in any case in contact with said interface surface 140, the transfer of electric energy between the wireless transmitter 110 and the device 500 can occur correctly.

The interface surface 140 substantially may be planar and orthogonal to the winding axis A of the inductive transmission coil 115, for example parallel and facing the flat surface 125 of the body 120 made of ferromagnetic material.

The interface surface 140 may be indicated for example, by means of a graphic, touch and/or illuminated indicator 145.

In order to keep the device 500 to be powered in contact with the interface surface 140 while simultaneously facilitating the correct centring between the wireless transmitter 110 and the corresponding wireless receiver of the device to be powered 500, the power base 100 may comprise at least one electromagnet 150.

The electromagnet 150 may be received in the casing 105 and generally is adapted to generate a magnetic pull from the outside towards the interface surface 140.

In practice, the electromagnet 150 is adapted to generate a magnetic pull having at least one component in direction that is orthogonal to the interface surface 140 and facing towards the inside of the casing 105.

In this way, the electromagnet 150 is capable of acting on the metal portions of the device 500 to be powered, for example on the ferromagnetic core of the inductive receiving coil (see the body 520 made of ferromagnetic material in FIG. 6), pulling it towards and in contact with the interface surface 140 of the power base 100.

In certain embodiments, the electromagnet 150 could be an independent component and separate from the wireless transmitter 110.

However, to reduce the number of components and accordingly the costs and overall dimensions of the power base 100, it is preferable for the electromagnet 150 to be at least partly integrated in the wireless transmitter 110.

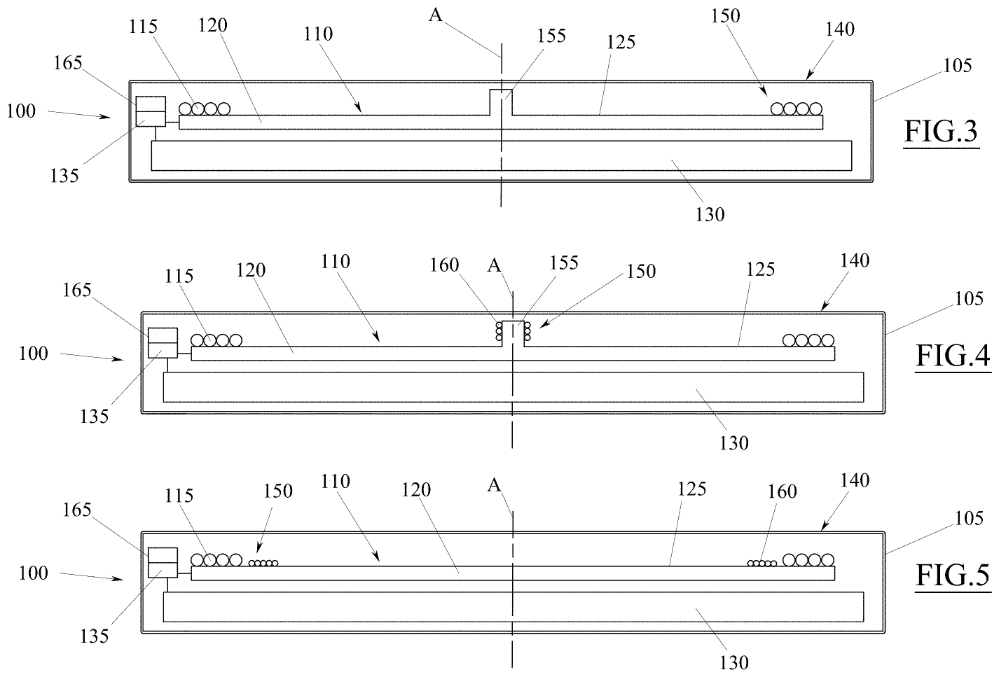

For example, in the embodiment of FIG. 3, the electromagnet 150 comprises (or consists of) the inductive transmission coil 115.

By applying a direct current to said transmission coil 115, it is indeed possible to generate a magnetic force corresponding to the one generated by an electromagnet.

Here, the excitation circuit 135 may be configured to apply, to the inductive trans-mission coil 115, both the alternating current useful for transmitting electric power to the device 500 to be powered, and a direct current, possibly overlapping the alternating current, useful for generating the magnetic pull.

To increase the self-alignment effect, the body 120 made of ferromagnetic material may be provided with a protrusion 155, for example a cylindrical or frustoconical protrusion, which rises from the flat surface 125 centrally with respect to the inductive transmission coil 115.

In detail, the protrusion 155 may be made in a single piece with the body 120 made of ferromagnetic material, and rise from the portion of the flat surface 125 laterally delimited by the inductive transmission coil 115, i.e. of the turn radially closest to the winding axis A.

In particular, the protrusion 155 may be placed close to the winding axis A, preferably coaxial thereto.

With respect to the winding axis A, the protrusion 155 may have a reduced radial overall dimension in comparison with the radial extension of the transmission coil 115, and a height (in direction of the winding axis A) substantially equal to or greater than the thickness of the body 120 made of ferromagnetic material (in the same direction).

In the alternative embodiment of FIG. 4, the electromagnet 150 may comprise an auxiliary coil 160, which is independent of the inductive transmission coil 115 of the wireless transmitter 110.

This auxiliary coil 160 may be connected with the energizing electric circuit 135, which may be configured to power the inductive transmission coil 115 with the alternating current useful for transmitting electric power to the device 500 to be powered, and the auxiliary coil 160 with the direct current adapted to generate the magnetic pull.

However, it is not excluded in other embodiments, for the auxiliary coil 160 to be connected to an energizing electric circuit which is independent from the excitation circuit 135.

Also the auxiliary coil 160 is wound about a respective winding axis, i.e. it comprises a body made of electrically conductive material (e.g. a wire or conductive foil) that is wound about said winding axis so as to form one or more turns that may be coplanar or axially overlapping.

The auxiliary coil 160 preferably is arranged so that the winding axis therefore centrally crosses the inductive transmission coil 115, i.e. passes in the space delimited by the most inner turn thereof.

The winding axis of the auxiliary coil 160 in particular may be parallel to, and possibly coinciding with, the winding axis A of the inductive transmission coil 115. The auxiliary coil 160 may share the same magnetic core with the inductive trans-mission coil 115, i.e. it may be associated with the same body 120 made of ferromagnetic material.

For example, the auxiliary coil 160 may be wound about the protrusion 155, as shown in FIG. 4.

Or, as illustrated in FIG. 5, the auxiliary coil 160 may be applied coplanar on the flat surface 125, both external to and centrally (inside) with respect to the inductive transmission coil 115.

In this second case, the body 120 made of ferromagnetic material might possibly not have the protrusion 155.

In any case, it is worth noting that the body made of electrically conductive material that forms the auxiliary coil 160 may have smaller diameter/thickness with respect to the one forming the inductive transmission coil 115, thus allowing an economical saving and, the space occupied being equal, an increase of the number of turns and therefore of the magnetic force that can be generated.

Irrespective of the specific embodiment, the power base 100 may comprise an electronic control arrangement 165, which is configured to control the activation and the shutdown both of the wireless transmitter 110 and of the electromagnet 150.

In other words, the electronic control arrangement 165 may be configured to control the power supply of alternating current to the inductive transmission coil 115 and, according to the embodiment, to control the power supply of direct current to the inductive transmission coil 115 itself or to the auxiliary coil 160.

In this regard, it is worth noting that the inductive transmission coil 115 may be powered simultaneously both with alternating current and with direct current, thus overlapping the operation as electromagnet with the transmission of electric power. Returning to the electronic control arrangement 165, it may be configured to activate the electromagnet 150 in a simultaneous and overlapping manner with the activation of the wireless transmitter 110.

In this way, during the transmission of electric energy towards the device 500 to be powered, the power base 100 advantageously is capable of also exerting a simultaneous magnetic pull that keeps the two devices joined, thus preventing them from being separated or in any case misaligned due to knocks, movements or other external stresses, in particular but not exclusively, in situations of mobility.

Alternatively, the electronic control arrangement 165 could be configured to activate the electromagnet 150 in an alternative manner with respect to the wireless transmitter 110.

Thanks to this solution, the electromagnet 150 is only used when electric power is not being transmitted and vice versa, thus obtaining a savings in terms of energy consumption.

It is in any case preferable in both cases for the electronic control arrangement 165 to be configured to activate the electromagnet 150 for a predetermined time period, typical lasting less with respect to the time period for activating the wireless transmitter 110.

In this way, the magnetic field is generated for relatively short periods of time, reducing the consumption and the possibility of generating harmful eddy currents in the device 500 to be powered, for example in the battery thereof.

For example, the electronic control arrangement 165 may be configured to activate the electromagnet 150 for a predetermined time period when an inductive coupling is detected between the wireless transmitter 110 and the wireless receiver of the device 500 to be powered, so as to possibly align them prior to beginning the trans-mission of electric power.

Furthermore, it may be provided for the electronic control arrangement 165 to be configured to activate the electromagnet 150 for a predetermined time period when a worsening is detected of the transmission efficiency of the electric power between the wireless transmitter 110 and the wireless receiver so as to restore the correct alignment.

This realignment may be carried out by temporarily interrupting the transmission of electric power or while electric power continues being transmitted.

A further configuration may provide for the electronic control arrangement 165 to be configured to activate the electromagnet 150 periodically for short intervals of time, alternated by periods of interruption, in order to ensure a constant contact and centring of the two devices.

Although in the embodiments hereto illustrated, the electromagnet 150 is in the power base 100, it is possible for a similar electromagnet to be in the device 500 to be powered.

For example, FIG. 6 illustrates a device 500 to be powered comprising a casing 505, which externally makes available an interface surface 540 adapted to rest on, or in any case be in contact with, the power base 100.

The device 500 to be powered comprises a wireless receiver 510, which is adapted to be coupled to the wireless transmitter 110 of the power base 100 (which in this embodiment might not have the electromagnet 150).

In particular, the wireless receiver 510 may comprise an inductive receiving coil 515 wound about a pre-set winding axis B, for example orthogonal to the interface surface 540.

The inductive receiving coil 515 may be associated with a body made of ferromagnetic material 520, for example made of ferrite, so that a magnetic field linked to the body 520 made of ferromagnetic material induces an electric current in the inductive receiving coil 515.

The body 520 made of ferromagnetic material may be shaped like a plate, which may be provided with a flat surface 525 and possibly with a protrusion 555, for example a cylindrical or frusto-conical protrusion, which rises from said flat surface 525 and is placed centrally with respect to the inductive receiving coil 515.

The device 500 to be powered also comprises at least one electromagnet 550, for example received in the casing 505.

The electromagnet 550 generally is adapted to generate a magnetic pull from the outside of the casing 505 towards the interface surface 540.

In this way, the electromagnet 550 is capable of acting on the metal portions of the power base 100, for example on the ferromagnetic core 120 of the inductive trans-mission coil 115, pulling it towards and in contact with the interface surface 540 of the device 500 to be powered.

In certain embodiments, the electromagnet 550 could be an independent component and separate from the wireless receiver 510.

However, to reduce the number of components and accordingly the costs and overall dimensions of the device 500 to be powered, it is preferable for the electromagnet 550 to be at least partly integrated in the wireless receiver 510.

In particular, in the embodiment of FIG. 6, the electromagnet 550 comprises an auxiliary coil 560, which is independent of the inductive receiving coil 515 of the wireless receiver 510.

This auxiliary coil 560 may be connected with an energizing electric circuit 535, which may be configured to power said auxiliary coil 560 with a direct current DC adapted to generate the magnetic pull.

Also the auxiliary coil 560 is wound about a respective winding axis.

The auxiliary coil 560 preferably is arranged so that the winding axis therefore centrally crosses the inductive receiving coil 515, i.e. crosses the space delimited by the most inner turn thereof.

The winding axis of the auxiliary coil 560 in particular may be parallel, and possibly coinciding, with the winding axis B of the inductive receiving coil 515.

The auxiliary coil 560 may share the same magnetic core with the inductive receiving coil 515, i.e. it may be associated with the same body 520 made of ferromagnetic material.

For example, the auxiliary coil 560 may be applied coplanar to the flat surface 525, or as illustrated in the drawings, it may be wound about the protrusion 555.

In any case, the auxiliary coil 560 preferably is positioned centrally with respect to the inductive receiving coil 515.

Alternatively or additionally, the electromagnet 550 could comprise (or consist of) the inductive receiving coil 515.

Here, an energizing electric circuit 535 could therefore be configured to apply, to the inductive receiving coil 515, the direct current required to generate the magnetic pull.

Also in this case, it in any case is preferable for the body 520 made of ferromagnetic material to be provided with the protrusion 555 so as to increase the self-alignment effect.

Irrespective of the specific embodiment, the device 500 to be powered could also comprise an electronic control arrangement 565 configured to control the activation and the shutdown of the electromagnet 550.

In particular, this electronic control arrangement 565 could be configured to exe-cute the same control logics described above with reference to the power base 100.

Although reference in the above description was always made to a transmission system of the electric power in an inductive way, it is not excluded in other embodiments for the transmission system of the electric power to be of the capacitive type.

In this case, the wireless transmitter 110 could comprise at least two armatures (e.g. plates or foils made of electrically conductive material) adapted to be capacitively coupled with at least two corresponding armatures of the device 500 to be powered, which would define the wireless receiver 510, so as to overall create a pair of capacitances through which the transfer of the electric energy may occur. Naturally, in the case of capacitive coupling, the electromagnetics 150 and/or 550 should be made as independent components and be suitably arranged with respect to the corresponding armatures.

Finally, it is worth noting that while a single electromagnet 150 or 550 is always present in the embodiments illustrated, other embodiments could provide for the power base 100 and/or the device 500 to be powered to comprise a plurality of electromagnets.

Obviously, an expert in the field may make several technical-applicative modifications to all that above, without departing from the scope of the invention as herein-below claimed.

1. An electric power base comprising:
a casing,
a wireless transmitter of electric energy placed in the casing, and
an interface surface placed external to the casing at said wireless transmitter which is adapted to receive in contact a device to be powered, and
at least one electromagnet adapted to generate a magnetic pull from the outside towards the interface surface.

2. An electric power base according to claim 1, wherein said wireless transmitter is of the inductive type and comprises an inductive transmission coil wound about a preset winding axis (A).

3. An electric power base according to claim 2, wherein the electromagnet comprises the inductive transmission coil of the wireless transmitter.

4. A power base according to claim 3, comprising an energizing electric circuit configured to power said inductive transmission coil both with an alternating current and with a direct current.

5. An electric power base according to claim 4, wherein the inductive transmission coil is associated with a body made of ferromagnetic material.

6. An electric power base according to claim 5, wherein the body made of ferromagnetic material is provided with a flat surface and a protrusion which rises from said flat surface centrally with respect to the inductive transmission coil.

7. A power base according to claim 2, wherein the electromagnet comprises an auxiliary coil which is independent of the inductive trans-mission coil (115).

8. A power base according to claim 7, wherein the auxiliary coil is wound about a winding axis passing through the inductive transmission coil and parallel to the winding axis (A) thereof.

9. An electric power base according to claim 7, wherein the inductive transmission coil is associated with a body made of ferromagnetic material, to which also the auxiliary coil is associated.

10. An electric power base according to claim 9, wherein the body made of ferromagnetic material is provided with a flat surface and a protrusion which rises from said flat surface centrally with respect to the inductive transmission coil, and wherein the auxiliary coil is at least partly wound on the protrusion of said body made of ferromagnetic material.

11. An electric power base according to claim 1, comprising an electronic control arrangement configured to activate the electromagnet at the same time as the wireless transmitter.

12. An electric power base according claim 1, comprising an electronic control arrangement configured to alternately activate the electromagnet or the wireless transmitter.

13. An electric power base according to claim 1, comprising an electronic control arrangement configured to activate the electromagnet for a predetermined time period.

14. A power base according claim 1, comprising an accumulator of electric energy connected to the wireless transmitter.

15. A device to be powered comprising:
a casing,
a wireless receiver of electric energy placed in the casing, and
an interface surface placed external to the casing at said wireless receiver which is adapted to receive in contact an electric power base, and
at least one electromagnet adapted to generate a magnetic pull from the outside towards the interface surface.
